(19) United States
(12) Patent Application Publication
(10) Pub. No.: US 2014/0311252 A1
(43) Pub. Date: Oct. 23, 2014

(54) METHOD AND CIRCUIT FOR GRID SYNCHRONIZATION OF A MAGNETO INDUCTIVE FLOW MEASURING DEVICE

(71) Applicant: Endress + Hauser Flowtec AG, Reinach (CH)

(72) Inventor: Matthias Brudermann, Moehlin (CH)

(21) Appl. No.: 14/362,312

(22) PCT Filed: Nov. 22, 2012
(86) PCT No.: PCT/EP2012/073306

§ 371 Date: Jun. 2, 2014

(30) Foreign Application Priority Data
Dec. 6, 2011 (DE) 102011087827.0

(51) Int. Cl. G01F 1/58

(52) U.S. Cl. CPC G01F 1/58
USPC 73/861.11

(57) ABSTRACT

Circuit and method for grid synchronization of a magneto inductive flow measuring device having a measuring transducer and a power supply. A direct current signal for supplying the measuring transducer with power is transmitted from the power supply to the measuring transducer via two signal conductors, characterized by method steps as follows: producing at the power supply a differential synchronization signal for synchronizing the flow measurement with the grid frequency; transmitting the differential synchronization signal to the measuring transducer via the two signal conductors; separating at the measuring transducer the differential synchronization signal from the direct current signal; and processing the differential synchronization signal for synchronizing the flow measurement with the grid frequency.

The present invention relates to a method and a circuit for grid synchronization of a magneto inductive flow measuring device having a measuring transducer and a power supply, wherein a direct current signal for supplying the measuring transducer with power is transmitted from the power supply to the measuring transducer via two signal conductors.

Compact magneto inductive flow measuring devices having a power supply grid connection, for example, a 50 Hz 230 volt AC grid, usually have means for grid synchronization, in order to filter out possible disturbances from the grid. For example, the transfer function of the signal processing of the magneto inductive flow measuring device has a zero position at the grid frequency, for example, at exactly 50 Hz. For this, the integration time of the measuring electrode signals is synchronized with the grid frequency. A disturbance from the grid would be correspondingly filtered out and the measurement signal quality decisively improved. Compact magneto inductive flow measuring devices generate a grid synchronization signal directly in the power supply, which, most often, is a component of the measurement transmitter, where the measuring signals and the grid synchronization signal are processed. For remote magneto inductive flow measuring devices, however, the grid synchronization signal must be transmitted from the measurement transmitter with power supply to the remotely arranged measuring transducer. The distance can, in such case, amount to a number of hundred meters. An example would be to use two extra cables for transmission of the grid synchronization signal from the measurement transmitter with power supply to the remotely arranged measuring transducer.

An object of the invention is to provide a method, which enables jitter free transmission of a synchronization signal via a cable to a remote measuring transducer.

The object is achieved by the subject matter of independent claims 1 and 6. Further developments and embodiments of the invention are set forth in the dependent claims.

For the grid synchronization of the invention, a magneto inductive flow measuring device includes a measuring transducer and a power supply. The power supply is, for example, part of a measurement transmitter, especially a measurement transmitter separated from the measuring transducer, i.e. the measurement transmitter is arranged remotely from the measuring transducer. This remoteness can amount to a number of hundred meters. For supplying the measuring transducer with power, a direct current signal is transmitted from the power supply to the measuring transducer via two signal conductors.

The magneto inductive flow measuring device is, in such case, fed from the supply grid. The power supply of the magneto inductive flow measuring device is, in such case, connected to the grid and converts the grid signal, especially an alternating current signal, into a direct current signal. In Germany, the supply grid is an alternating current grid with 230 volt grid voltage and 50 Hz grid frequency. In the United States of America, the grid frequency is, in contrast, 60 Hz. The power supply also supplies the measurement transmitter with energy.

According to the invention, at the power supply, thus, for example, in the power supply, a differential synchronization signal is produced for synchronizing the flow measurement by means of the measuring transducer with the grid frequency. Then, this differential synchronization signal is transmitted to the measuring transducer via the two signal conductors, via which the direct current signal for supplying power to the measuring transducer is also transmitted. The differential synchronization signal is modulated onto the direct current signal. In this way, an extra cable for separate transmission of direct current signal and synchronization signal is not required.

At the measuring transducer, the differential synchronization signal is then removed from the direct current signal and correspondingly further processed, especially in the measuring transducer, for synchronizing the flow measurement with the grid frequency.

A differential signal in general and the differential synchronization signal in particular are composed of an inverted signal and a non-inverted signal, for example, a voltage signal or an electrical current signal. The inverted signal has at all times the same magnitude as the non-inverted signal, but is, however, of reversed sign.

A circuit of the invention for performing the method of the invention includes, consequently, at the power supply, means for producing a synchronization signal for synchronizing the flow measurement by means of the measuring transducer with the grid frequency of the supply grid. The power supply is, in such case, especially part a measurement transmitter, which is separated from the measuring transducer. Furthermore, the circuit includes means suitable for producing, at the power supply, a differential synchronization signal for synchronizing the flow measurement with the grid frequency and means to transmit the differential synchronization signal on the two signal conductors to the measuring transducer. Moreover, the circuit includes, at the measuring transducer, means to separate the differential synchronization signal and the direct current signal from one another and means for processing the differential synchronization signal for synchronizing the flow measurement with the grid frequency.

Especially, the means produce, at the power supply, mutually inverted pulse signals, which are impressed via other means onto the direct current signal and transmitted via the two signal conductors, especially a cable, especially a twisted pair cable (TP), which especially is shielded, and, at the measuring transducer, then separated by additional means.

A further advantage of the invention is that no additional jitter is impressed on the synchronization signal by a circuit of the invention.

In a first further development of the method of the invention, production of the differential synchronization signal is preceded by the following method steps: producing a rectangular voltage signal and producing a differential voltage signal as differential synchronization signal with pulses instead of edges of the rectangular voltage signal.

The differential synchronization signal is composed, thus, of an inverted pulse, voltage signal and a non-inverted pulse, voltage signal. The pulses of the pulse, voltage signals are produced at the same time at the edges of the rectangular voltage signal and therewith are in phase with the rectangular voltage signal, respectively the grid signal.

If the grid frequency fluctuates, so also does the synchronization signal change in equal measure. For example, a pulse of the differential synchronization signal, respectively an edge of the rectangular voltage signal, is produced at each zero crossing of a sinusoidal grid signal. There are, however, also other types of synchronizing conceivable.

In a further development of the invention, a circuit of the invention includes means to produce a rectangular voltage signal synchronously to grid frequency and to produce the differential synchronization signal as a differential voltage signal with pulses instead of the edges of the rectangular voltage signal. Edges of the rectangle are produced, for example, in the case of a zero crossing of the grid signal. However, also only rising edges in the case of a positive zero crossing of the grid signal can be produced, i.e. in the instant, when the grid signal is negative and becomes positive, and the time to the falling edge is predetermined, especially constant. The pulse pause ratio amounts, according to an example of an embodiment, to 1:1 and the frequency equals the grid frequency. The named pulse pause ratio is, however, same as the frequency equality, not essential to the invention. Thus, in the case of a 50 Hz grid signal, each half-wave could trigger an edge, so that the frequency of the synchronization signal would be 100 Hz. In each case, the grid signal, the differential synchronization signal and, in given cases, the rectangular voltage signal are synchronized with one another. A circuit of the invention includes correspondingly thereto suitable means to produce the differential synchronization signal as differential a voltage signal with pulses at the same time as the edges of the rectangular voltage signal.

The rectangular voltage signal is produced with an optocoupler circuit known from the state of the art. For example, the rectangular voltage signal is a TTL signal, e.g. of 0 to 3 volt or of 0 to 5 volt.

In an additional further development of the invention, a circuit of the invention includes an EIA-485-transmitter, sometimes also referred to as an RS 485 transmitter or a differential driver stage, and, in each case, a capacitor between the EIA-485-transmitter and respective signal conductors as means for producing the differential synchronization signal as a differential pulse, voltage signal with pulses instead of edges of the rectangular voltage signal. As already mentioned, the pulses of the differential pulse, voltage signal are produced at the same time as the rising edges or at the same time as the falling edges or at the same time as rising and falling edges of the rectangular voltage signal.

For this, the EIA-485 transmitter, first of all, inverts the rectangular voltage signal as input signal and outputs this inverted rectangular voltage signal via a first output. Additionally, the rectangular voltage signal is output as the non-inverted input signal via a second output. Any other equally acting component, especially electronic component of equal functionality, can equally bring about this technical effect and would be considered as an equivalent.

The differential rectangular voltage signal is then led to the two capacitors. In each case, a capacitor is arranged between one output of the EIA-485-transmitter and one of the two signal conductors. Each of the two capacitors produces a positive voltage pulse in the case of a rising edge of the rectangular voltage signal and a negative voltage pulse in the case of a falling edge of the rectangular voltage signal, and these are superimposed on the direct current signal. Due to the differential nature of the rectangular voltage signal, consequently, two, pulse, voltage signals are produced, wherein the one is inverted relative to the other. There lies, thus, a differential pulse, voltage signal on the capacitors.

In a form of embodiment of the invention, the two capacitors have a capacitance of, in each case, 100 nF to 100 μF, especially, in each case, 100 nF to 1 μF.

After transmission via the two signal conductors, the differential synchronization signal and the direct current signal are according to the invention separated from one another. Then, the signals are further processed separately from one another.

For the separating, the circuit includes at least one coil at each end of the signal conductors, in each case, after the output of the power supply and before the input to the measuring transducer, wherein the additional circuit components are arranged therebetween at the power supply and at the measuring transducer. The magneto inductive flow measuring device includes a power supply, for example, as part of a measurement transmitter, two signal conductors and a measuring transducer, wherein the power supply is connected with the measuring transducer via the two signal conductors, in order to transmit a direct current signal from the power supply to the measuring transducer for supplying power to the measuring transducer.

The coils have, in such case, an inductance of, in each case, 100 μH to 100 mH, especially of 1 mH to 10 mH.

In a further development of the invention, for processing the differential synchronization signal for synchronizing the flow measurement with the grid frequency, the following method step is performed, which then, in given cases, precedes the producing of the rectangular voltage signal with edges instead of the pulses of the differential voltage signal: filtering the differential synchronization signal with a low-pass filter, which is so set that pulses with a frequency above a predetermined first threshold value, which especially depends, on its part, on the expected grid frequency, are filtered out from the synchronization signal.

Along with that, the differential synchronization signal can also be filtered with a highpass filter, which highpass filter is so set that pulses with a frequency below a predetermined second threshold value, which depends, for example, on its part, on the expected grid frequency, are filtered out from the synchronization signal. The lowpass and highpass filters form together a bandpass filter. The first threshold value lies, in such case, higher than the second threshold value. In the case of an expected grid frequency of 50 Hz, the band formed by the first and second threshold values lies, for example, from 40 to 60 Hz or even only from 48 to 52 Hz. Of course, also the subsequently formed rectangular voltage signal can first be filtered for the synchronizing, such as described below. Low-, high- and bandpass filters can be implemented, for example, with software.

In a further development of the circuit of the invention, the lowpass filter is formed using capacitors and resistors connected in parallel to form a lowpass component.

Then, according to a further development of the invention, the differential synchronization signal for synchronizing the flow measurement with the grid frequency is processed to produce a rectangular voltage signal with edges instead of the pulses of the differential voltage signal. The edges of the so produced rectangular voltage signal are, analogously to the producing of the pulse, voltage signal, in phase with the pulses of the pulse, voltage signal, since they are produced at the same time as these.

For producing the rectangular voltage signal, for example, a difference amplifier, e.g. an operational amplifier or an RS485 transceiver, with difference inputs is used, especially with at least one capacitor between each input of the operational amplifier and one of the signal conductors.

Additionally, a mono-flop can be used as a digital gate, which especially is connected with the output of the operational amplifier.

Furthermore, the circuit of the invention can have a computing unit, which is suitable by means of software to fade-in the synchronization signal only at desired points in time and otherwise to output a predetermined signal, for example, a constant voltage, especially of 0 volt. The synchronization signal, for example, the rectangular voltage signal or, however, also the differential synchronization signal are, thus, virtually yet again bandpass filtered. The duration between the periods or windows, in which the synchronization signal is masked out, is predetermined and timed especially based on the expected grid frequency and the present synchronization signal, and is therewith exactly so adjustable as the length of the periods or windows, in which the synchronization signal is faded in and therewith output for further processing.

In a further example of an embodiment of the invention, a twisted pair cable is provided for transmission of the direct current signal and the synchronization signal. In this case, the two signal conductors are twisted with one another. The twisted pair cable includes, in such case, especially an electrically conducting shield.

Each circuit of the invention is suitable for executing the method of the invention.

The invention permits numerous forms of embodiment. Some thereof will now be explained in greater detail based on the figures of the drawing, in which equal elements are provided in the figures with equal reference characters. The figures of the drawing show as follows:

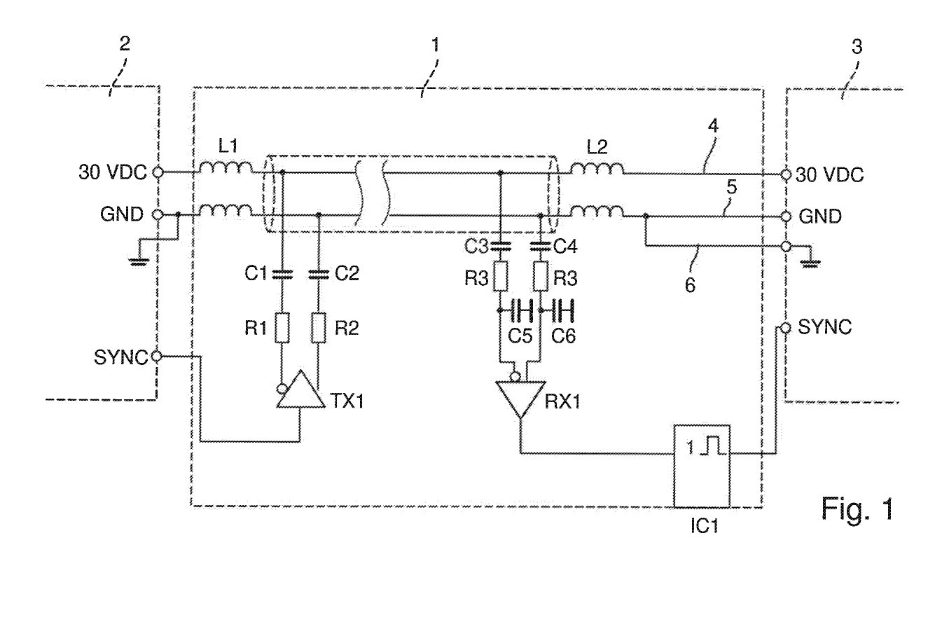

FIG. 1 a circuit of the invention for grid synchronization,

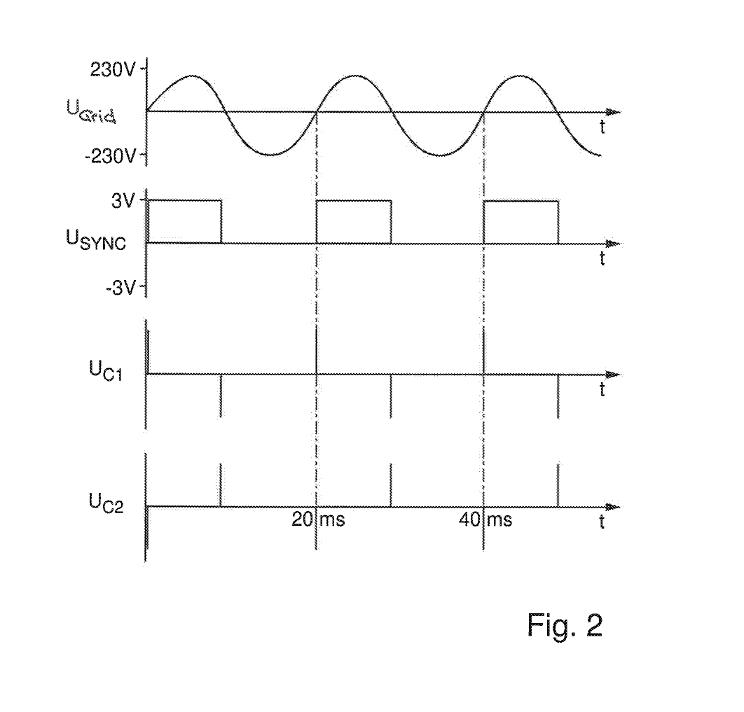

FIG. 2 a number of signal curves, or waveforms, plotted versus time.

FIG. 1 shows a circuit of the invention 1 for grid synchronization. A power supply 2 converts a grid signal, here, for example, an alternating current signal with 230 volt grid voltage and 50 Hz grid frequency, into a direct current signal, here with 30 volt. The direct current signal is transmitted via two signal conductors 4 and 5 to the measuring transducer 3. The two signal conductors 4 and 5 are connected to the outputs 30 VDC and GND of the power supply 2 and of the measuring transducer 3. The connection of the power supply to the supply grid is likewise not shown, as well as that the power supply 2 is part of a measurement transmitter of the magneto inductive flow measuring device.

The power supply 2 produces, besides the direct current signal, a synchronization signal for synchronizing the flow measurement by means of the measuring transducer with the grid frequency. The synchronization signal lies on the output SYNC of the power supply 2 and is output there. The synchronization signal is produced according to the state of the art as a rectangular voltage signal synchronous to the grid signal. It has especially the same frequency as the grid signal, wherein it has, for example, rising edges at the same time as a zero crossing from the negative into the positive of the grid signal. If the grid signal jitters, then the rectangular voltage signal jitters equally.

Now, the measuring transducer 3 includes an input SYNC, which can process such a rectangular voltage signal for synchronizing the flow measurement with the grid signal. The transmission of such a rectangular voltage signal is, however, disadvantageous.

Therefore, the circuit 1 of the invention illustrated here includes means to convert the rectangular voltage signal into a differential pulse, voltage signal as synchronization signal. Here, the means comprises an EIA-485 transmitter TX1 and two capacitors C1 and C2 and two resistances R1 and R2, wherein, in each case, a capacitor C1 and C2 and, in each case, a resistor R1 and R2 are connected in series and arranged between an output of the EIA-485 transmitter TX1 and one of the signal conductor 4 and 5 and connected with these electrically conductively, especially galvanically.

The rectangular voltage signal, which lies on the input of the EIA-485 transmitter TX1, is output by it non-inverted and inverted. The signal curves, or waveforms, are sketched in FIG. 2. Subsequently, the now differential rectangular voltage signal is converted into a differential pulse, voltage signal by the series connected capacitors C1 and C2 and resistors R1 and R2, and is modulated onto the two signal conductors 4 and 5. The capacitors C1 and C2 serve for capacitive coupling, while the resistances R1 and R2 serve for amplitude limiting, or, in other words, for attenuation, of the synchronization signal, so that it is assured that a maximum amplitude of the signal transmitted via the signal conductor 4 is not exceeded.

Thus, no supplemental cable is necessary for transmission of the synchronization signal. Because the rectangular voltage signal as output signal was produced synchronously to the grid signal, then also the differential pulse, voltage signal is synchronous to such. The EIA-485 transmitter TX1 is, in given cases, supplied with energy, usually with 3.3 volt, by the power supply 2.

At the measuring transducer, now the differential synchronization signal is then separated from the direct 1 current signal. In this regard, the circuit of the invention includes at the measuring transducer an operational amplifier or an EIA-485 receiver RX1 with differential inputs and, in each case, a capacitor C3, C4 connected in series with a resistor R3, R4 between an input of the differential operational amplifier or of the EIA-485-Receiver RX1 and a signal conductor 4, 5 as means for producing a rectangular voltage signal with edges instead of the pulses of the differential voltage signal. Capacitors C3 and C4 couple the differential synchronization signal capacitively. RX1 is in advantageous manner also an RS485 standard chip and is then supplied with 3.3 volt from the measuring transducer 2. Capacitors C3 and C4 are required, in order to block the supplied DC voltage, which is transmitted via the cable, from the receiver RX1.

Moreover, the circuit 1 shown here includes a low pass component between each signal conductor 4 and 5 and, in each case, an input of the differential EIA-485 receiver RX1. The low pass components are formed in simple manner, in each case, from capacitors C5 and C6 connected parallel to the resistors R3 and R4. The low pass components filter out undesired disturbance signals before they can get to the EIA-485 receiver RX1.

The capacitances of the capacitors C1, C2, C3 and C4 are, in such case, at most 100 μF, especially at most 1 μF. The resistances R1, R2, R3 and R4 are at least 10 ohm, especially at least 700 ohm. Also, the cable with the two signal conductors between power supply and measuring transducer has a resistance and, in given cases, a capacitance, e.g. between 20 pF/m to 200 μF/m and 1 mOhm/m to 10 Ohm/m. Due to the cable resistance as well as the internal resistance of the RS485-modules as well as leakage currents, the capacitors are discharged. They serve to transmit energy potential freely.

The capacitors and resistances R3/C5 and R4/C6 connected in parallel form low-pass filters for low-pass filtering. The capacitances of the capacitors C5 and C6 are, in such case, at most 100 μF, especially at most 5 μF and the resistors R3, R4 are at least 10 ohm, especially at least 700 ohm.

Here also a supplemental mono-flop IC1, a monostable multivibrator, is connected as a digital gate between the input SYNC of the measuring transducer 2 and the output of the EIA-485 receiver RX1. The mono-flop IC1 prevents that a plurality of pulses, e.g. caused by disturbances, lead to false triggering.

The exploitation of the synchronization signal, which lies on the input SYNC of the measuring transducer, occurs, for example, with software. This applies a window method, which receives the signals only in a predetermined time interval, in order to make the circuit disturbance safe. If disturbance pulses occur outside this window, they are ignored.

Inductors L1 and L2 are electrical current compensated chokes. They serve for separating the direct current signal and the differential pulse, voltage signal. The coil L1 prevents, in such case, the differential pulse, voltage signal from being short circuited by the power supply of the measurement transmitter. The coil L2 prevents the differential pulse, voltage signal from getting into a power supply of the measuring transducer 3.

In order to further reduce disturbance susceptibility, the signal conductors 4 and 5 are combined in a cable, especially a twisted pair cable. In such case, the conductors are shielded against disturbances from the outside by a shield 6. In practice, the cable is composed of two TP pairs. The first pair is for the supply voltage 30VDC/GND and the second pair for a bus connection from the measuring transducer to the measurement transmitter. The second pair is not essential to the invention and is therefore not considered further.

Disturbances from the outside are, on the one hand, drained away by the shield, and, on the other hand, attenuated by the low pass filters R3/C5 and R4/C6. So-called common mode disturbances are significantly attenuated by the twisted pair cable. The differential EIA-485 receiver RX1 is immune to common mode disturbances, since it receives a differential signal.

Theoretically, this circuit could be used for the exchange of half duplex information between measuring transducer and measurement transmitter. Along with that, the circuit of the invention enables a jitter free synchronization signal to be transmitted, without requiring another signal line, since the in any event present, supply cable is utilized, wherein the level of the supply voltage, here 30 volt, has no influence on the synchronization signal and, conversely, the encoding of the synchronization signal has no influence on the transmission of the supply signal. The synchronization signal, for example, does not have to be mean value free. This is, above all, advantageous in the case of remote magneto inductive flow measuring devices having a separation of measurement transmitter and measuring transducer of a number of meters, for example, up to 300 m.

Only for clarity of explanation is the circuit of the invention here not a part of the power supply, respectively measuring transducer. Thus, the circuit components of the circuit of the invention at the power supply can be integrated into the power supply, respectively into the measurement transmitter and/or those at the measuring transducer can be integrated into the measuring transducer, so that on the outputs of the power supply already the direct current signal with the modulated differential synchronization signal is present and correspondingly this signal is tapped on the inputs of the measuring transducer, where it then is internally demodulated and further processed.

The individual signals are shown in FIG. 2 versus time. The signal on the SYNC output of the power supply is here a rectangular voltage signal with a pulse pause ratio of 1:1 and a separation between two rising edges of 20 ms. This is the second waveform from the top and has rising edges, which are at the same time as the positive zero crossings of the sinusoidal grid signal of 50 Hz, the first waveform from the top. Instead of zero, also any other preselected threshold value can be subceeded, respectively exceeded, in order to produce an edge.

The third and fourth waveforms show voltage as a function of time at the capacitors C1 and C2. The pulses are at the same time as the edges of the rectangular voltage signal, and therewith synchronous to the zero crossings of the grid signal. Not presented are the waveforms at the outputs of the EIA-485 transmitter, since the waveform on one output corresponds to the waveform of the rectangular voltage signal and the waveform on the other output simply to the inversion thereof.

### LIST OF REFERENCE CHARACTERS

1 circuit
2 power supply
3 measuring transducer
4 first signal conductor
5 second signal conductor
6 shield

1-15. (canceled)

16. A method for grid synchronization of a magneto inductive flow measuring device having a measuring transducer and a power supply, wherein a direct current signal for supplying the measuring transducer with power is transmitted from the power supply to the measuring transducer via two signal conductors, the method comprising:
producing at the power supply a differential synchronization signal for synchronizing the flow measurement with the grid frequency;
transmitting the differential synchronization signal to the measuring transducer via the two signal conductors;
separating at the measuring transducer the differential synchronization signal from the direct current signal; and
processing the differential synchronization signal for synchronizing the flow measurement with the grid frequency.

17. The method as claimed in claim 16, wherein:
the differential synchronization signal is produced as follows:
producing a rectangular voltage signal; and
producing a differential voltage signal as differential synchronization signal with pulses at the same time as edges of the rectangular voltage signal.

18. The method as claimed in claim 17, wherein:
the rectangular voltage signal is produced with a frequency equaling the grid frequency.

19. The method as claimed in claim 16, wherein:
for processing the differential synchronization signal for synchronizing the flow measurement with the grid frequency, further method steps are performed as follows:
filtering the differential synchronization signal with a low-pass filter, which is so set that pulses with a frequency above a predetermined threshold value are filtered out from the synchronization signal.

20. The method as claimed in claim 16, wherein:
for processing the differential synchronization signal for synchronizing the flow measurement with the grid frequency, further method steps are performed as follows:
producing a rectangular voltage signal with edges at the same time as the pulses of the differential voltage signal.

21. A circuit for grid synchronization of a magneto inductive flow measuring device, having:
a measuring transducer;
a power supply; and
two signal conductors for transmission of a direct current signal from said power supply to said measuring transducer for supplying said measuring transducer with power, wherein:
the circuit includes, at said power supply, means for producing a differential synchronization signal for synchronizing the flow measurement with a grid frequency; and
means for transmitting the differential synchronization signal on said two signal conductors to said measuring transducer, and, at said measuring transducer;
means for separating the differential synchronization signal and the direct current signal from one another; and
means for processing the differential synchronization signal for synchronizing the flow measurement with the grid frequency.

22. The circuit as claimed in claim 20, wherein:
it includes means for producing a differential voltage signal as a differential synchronization signal, which has equidistant and grid synchronous pulses.

23. The circuit as claimed in claim 20, wherein:
it includes means for producing a rectangular voltage signal equidistantly and grid synchronously and the differential synchronization signal as a differential voltage signal with pulses at the same time as the edges of the rectangular voltage signal.

24. The circuit as claimed in claim 23, wherein:
said means for producing the differential voltage signal with pulses instead of edges of the rectangular voltage signal includes an EIA-485 transmitter and a capacitor between each of the outputs of the EIA-485 transmitter and respective ones of the signal conductors.

25. The circuit as claimed in claim 24, wherein:
said two capacitors have a capacitance of 100 nF to 100 μF.

26. The circuit as claimed in claim 20, wherein:
for processing the differential synchronization signal for synchronizing the flow measurement with the grid frequency, at said measuring transducer, it includes means for producing a rectangular voltage signal with edges instead of the pulses of the differential voltage signal.

27. The circuit as claimed in claim 26, wherein:
for producing the rectangular voltage signal, it includes an EIA-485 receiver and a capacitor between each of the inputs of the EIA-485 receiver and respective ones of the signal conductor.

28. The circuit as claimed in claim 26, wherein:
for producing the rectangular voltage signal, it includes a mono-flop.

29. The circuit as claimed in claim 20, wherein:
it includes coils on each end of the signal conductors for separating the differential synchronization signal from the direct current signal.

30. The circuit as claimed in claim 20, wherein:
a twisted pair cable is provided for transmission of the direct current signal and the synchronization signal.
